(19) United States
(12) Patent Application Publication
(10) Pub. No.: US 2016/0097474 A1
(43) Pub. Date: Apr. 7, 2016

(54) CLICK-SEAL TORQUE LIMITING CONNECTOR DESIGNS

(71) Applicant: FLUIDMASTER, INC., San Juan Capistrano, CA (US)

(72) Inventors: Sasikumar Mylappan SETTU, Idappadi (IN); Jithin Karukasseril VIJAYAN, Kalpetta North PO (IN); Venkat MALLELA, San Marcos, CA (US)

(73) Assignee: FLUIDMASTER, INC., San Juan Capistrano, CA (US)

(21) Appl. No.: 14/891,414

(22) PCT Filed: May 13, 2014
(86) PCT No.: PCT/US2014/037928

§ 371 Date: Nov. 16, 2015

Related U.S. Application Data
(60) Provisional application No. 61/823,048, filed on May 14, 2013.

(51) Int. Cl. F16L 15/08; F16L 25/00; F16L 15/04

(52) U.S. Cl. CPC F16L 15/08; F16L 15/04; F16L 25/0018

(57) ABSTRACT

A fluid connector assembly comprises an outer fastener and an inner fastener. The outer fastener is comprised of a top surface, a bottom surface, and a plurality of radially extending members on the top surface. The inner fastener is provided comprising a top surface, a bottom surface, and a plurality of radially extending projections. The radially extending projections are dimensioned to be received by the radially extending members when the inner fastener is assembled with the outer fastener. A connector is disposed in the inner fastener, wherein the connector may be externally threaded so as to receive a fluid supply line that is internally threaded. The radially extending projections of the inner fastener may be flexible.

### RELATED APPLICATION

The present disclosure claims priority to U.S. Provisional Patent Application 61/823,048, entitled, CLICK-SEAL TORQUE LIMITING CONNECTOR DESIGNS, filed May 14, 2013, the full disclosure of which is incorporated herein by reference in its entirety.

### FIELD

The present disclosure relates to fluid connectors.

### BACKGROUND

A common concern with standard fluid connectors is that they can be overtightened. Overtightening connectors has resulted in many problems, including damage to the connector itself, damage to the surface of the object to which the connector is connected when overtightened, and damage to components positioned within the connector. These problems are especially common with plumbing connectors, for example when connecting water supply lines to toilet tanks, fill valves, or the like.

What is instead desired is a screw on fluid connector that cannot be overtightened, yet can still be easily loosened. It is also desirable that this screw on connector be hand-operated such that a user requires no special tool to operate or make adjustments.

What is also desirable is to provide a hand-operated connector that seals multiple types of fluid supply lines that extend from tanks, valves, other fixtures, or adjoining fluid supply lines.

### SUMMARY

The following simplified summary is provided in order to provide a basic understanding of some aspects of the claimed subject matter. This summary is not an extensive overview, and is not intended to identify key/critical elements or to delineate the scope of the claimed subject matter. Its purpose is to present some concepts in a simplified form as a prelude to the more detailed description that is presented later.

In one embodiment, a fluid connector assembly is provided comprising and outer fastener and an inner fastener. The outer fastener comprises a top surface, a bottom surface, and a plurality of radially extending members on the top surface. The inner fastener comprises a top surface, a bottom surface, and a plurality of radially extending projections dimensioned to be received by the radially extending members when the inner fastener is assembled with the outer fastener. A connector may be disposed in the inner fastener. In some embodiments, the connector is externally threaded. A seal may be provided in communication with the connector, wherein said connector further comprises a shoulder in communication with the seal.

In some embodiments, the radially extending projections of the inner fastener may be received by the radially extending members of the outer fastener, wherein when a predetermined torque is reached, the radially extending projections slip out of the radially extending members passing over the top surface of the outer fastener and preventing the predetermined torque from being exceeded. Further, the radially extending projections of the inner fastener may not slip out of the radially extending members when a loosening torque is applied to the connector assembly. Similarly, the loosening torque may be greater than the predetermined torque achieved during tightening. In some embodiments, the predetermined torque is adjustable.

The connector may also operatively connect to a first fluid supply line and the outer fastener may operatively connect to a second fluid supply line. The first or second supply line may be a conventional fluid hose. The second fluid supply line may be crimped to the outer fastener

In other embodiments, the fluid connector assembly comprises an outer fastener with a top surface, a bottom surface, and a plurality of extending members on the top surface. An inner fastener is provided comprising a top surface, a bottom surface, and a plurality of extending projections that are dimensioned to be received by the extending members when the inner fastener is assembled with the outer fastener. A connector is disposed in the inner fastener, wherein the extending projections of the inner fastener are received by the extending members of the outer fastener. When an adjustable predetermined torque is reached, the extending projections slip out of the extending members passing over the top surface of the outer fastener and prevent the adjustable predetermined torque from being exceeded.

In other embodiments, a method of connecting fluid supply lines to a fluid connector assembly is provided, wherein the method comprises the following steps: (a) fastening an externally threaded connector assembly to a first fluid supply line with internal threads, wherein the externally threaded connector assembly comprises: (i) an outer fastener comprising a top surface, a bottom surface, and a plurality of radially extending members on the top surface; (ii) a fastener insert comprising a top surface, a bottom surface, external threads, and a plurality of radially extending projections dimensioned to be received by the radially extending members when the fastener insert is assembled with the outer fastener; (b) rotating the outer fastener to rotably tighten the externally threads of the fastener insert to the internal threads of the first fluid supply line until a predetermined torque is reached. If the outer fastener continues to be rotated after the predetermined torque is reached, the radially extending projections of the fastener insert slip over the radially extending projections of the outer fastener. The first fluid source may be a pipe, a toilet tank, a spigot, or a fluid hose.

In other embodiments, a fluid connector assembly may comprise a first and a second outer fastener and a first and second corresponding fastener insert. Each outer fastener may comprise a front surface, a back surface, and a plurality of inwardly extending axial portions separated by axially extending slots. Each fastener insert may comprise a front surface, a back surface, threading, and a plurality of outwardly extending axial projections configured to be received by the axially extending slots when an associated fastener insert is assembled with an associated outer fastener. The first fastener insert in this embodiment is received by the first outer fastener and the second fastener insert is received by the second outer fastener, wherein the first and second fastener inserts interlock after being received by an associated outer fastener. A first fluid supply line with threading may be fastened to the assembly through the threading of the first fastener insert.

Similarly, a second fluid source with threading may be fastened to the assembly through the threading of the second fastener insert. The second fluid source with threading in this embodiment may be fastened to the assembly through the threading of the second fastener insert. The threading of each of the first and second fastener inserts may optionally be internal threading or external threading. Further, the first fastener insert may be internally threaded and the second fastener insert may be externally threaded. Moreover, the first fastener insert may be externally threaded and the second fastener insert may be internally threaded.

The first and second fastener inserts may be configured to snap onto each other after being received by an associated outer fastener. The axially extending projections of the first fastener inserts may be received by the axially extending slots of the first outer fastener, wherein when a predetermined torque is reached, the outwardly extending projections of the first fastener insert slip over the inwardly extending axial portions of the first outer fastener to prevent the predetermined torque from being exceeded. In this embodiment, the axially extending projections of the second fastener insert may be received by the axially extending slots of the second outer fastener, wherein when the predetermined torque is reached, the outwardly extending projections of the second fastener insert slip over the inwardly extending axial portions of the second outer fastener to prevent the predetermined torque from being exceeded.

In other embodiments, the axially extending projections of the second fastener insert are received by the axially extending slots of the second outer fastener, wherein when a predetermined torque is reached, the outwardly extending projections of the second fastener insert slip over the inwardly extending axial portions of the second outer fastener to prevent the predetermined torque from being exceeded. The outwardly extending projections of the first and second fastener inserts may also be flexible. In this regard, the outwardly extending projections of the first and second fastener inserts may not slip over the inwardly extending axial portions of the first and second outer fastener when a loosening torque is applied. Further, the loosening torque may be greater than the predetermined torque. The predetermined torque may also be adjustable.

In other embodiments, a method of connecting fluid supply lines to a fluid connector assembly comprises the following steps: (a) fastening threading of a first fluid supply line to a threaded connector assembly, wherein the threaded connector assembly comprises: (i) a first and a second outer fastener, each outer fastener comprising a front opening, a back opening, and a plurality of inwardly extending axial portions separated by axially extending slots; and (ii) a first and a second fastener insert, each fastener insert comprising threading, a front opening, a back opening, and a plurality of outwardly extending axial portions configured to be received by the axially extending slots when an associated fastener insert is assembled with an associated outer fastener; wherein the first outer fastener is assembled with the first fastener insert and the second outer fastener is assembled with the second fastener insert; and wherein the first and second fastener inserts interlock with each other at a corresponding back opening; (b) rotating the first outer fastener to rotably tighten the threading of the first fastener insert to the threading of the first fluid supply line until a predetermined torque is reached; and wherein if the first outer fastener continues to be rotated after the predetermined torque is reached, the outwardly extending projections of the first fastener insert slip over the inwardly extending axial portions of the first outer fastener to prevent the predetermined torque from being exceeded.

The method may comprise: (c) providing a second fluid supply line with threading; and (d) rotating the second outer fastener to rotably tighten the threading of the second fastener insert to the threading of the second fluid supply line until the predetermined torque is reached. In this embodiment, if the second outer fastener continues to be rotated after the predetermined torque is reached, the outwardly extending projections of the second fastener insert slip over the inwardly extending axial portions of the second outer fastener to prevent the predetermined torque from being exceeded. Further, the first or second fluid supply line may be a pipe, a toilet tank, a fluid spigot, or a fluid hose with internal threading or external threading.

To the accomplishment of the foregoing and related ends, certain illustrative aspects are described herein in connection with the following description and the annexed drawings. These aspects are indicative, however, of but a few of the various ways in which the principles of the claimed subject matter may be employed and the claimed subject matter is intended to include all such aspects and their equivalents. Other advantages and novel features may become apparent from the following detailed description when considered in conjunction with the drawings.

### BRIEF DESCRIPTION OF THE DRAWINGS

FIG. 1 is a schematic illustration of an unexploded view of a preferred embodiment of a fluid connector assembly with external threads.

FIG. 2 is an exploded view of the embodiment depicted in FIG. 1.

FIG. 3 depicts a side plan view of a cross section of the assembly of FIG. 1 taken along center line of the same.

FIG. 4 depicts a side of the inner ring of the assembly of FIG. 1.

FIG. 5 depicts an outer fastener mounting to a fastener insert of the fluid connector assembly of FIG. 1.

FIGS. 6-7 depict the fluid connector assembly of FIG. 1 in use with a fluid supply line such as a conventional garden hose.

FIG. 8 depicts a side plan view another fluid connector assembly.

FIG. 9 depicts a schematic illustration of an unexploded view of the fluid connector assembly of FIG. 8 with external threads.

FIG. 10 depicts an exploded view of the embodiment of FIG. 9.

FIG. 11 depicts a side plan view of a cross section along center line of the fluid connector assembly of FIG. 9.

FIGS. 12-13 depict the fluid connector assembly of FIG. 9 in use with multiple fluid supply lines such as a conventional fluid hose and a spigot.

FIG. 14 depicts a side plan view of a cross section along center line of another embodiment of a fluid connector assembly, wherein the upper and lower fastener inserts inserted into outer fastener each comprise internal threading.

FIG. 15 depicts the embodiment of FIG. 14 in use with multiple fluid supply lines such as a conventional fluid hose and a spigot.

FIG. 16 depicts a side plan view of a cross section along center line of another fluid connector assembly, wherein the upper and lower fastener inserts inserted into outer fastener each comprise external threading.

FIG. 17 depicts the embodiment of FIG. 16 in use with fluid sources such as a conventional fluid hose and a fluid valve.

### DETAILED DESCRIPTION

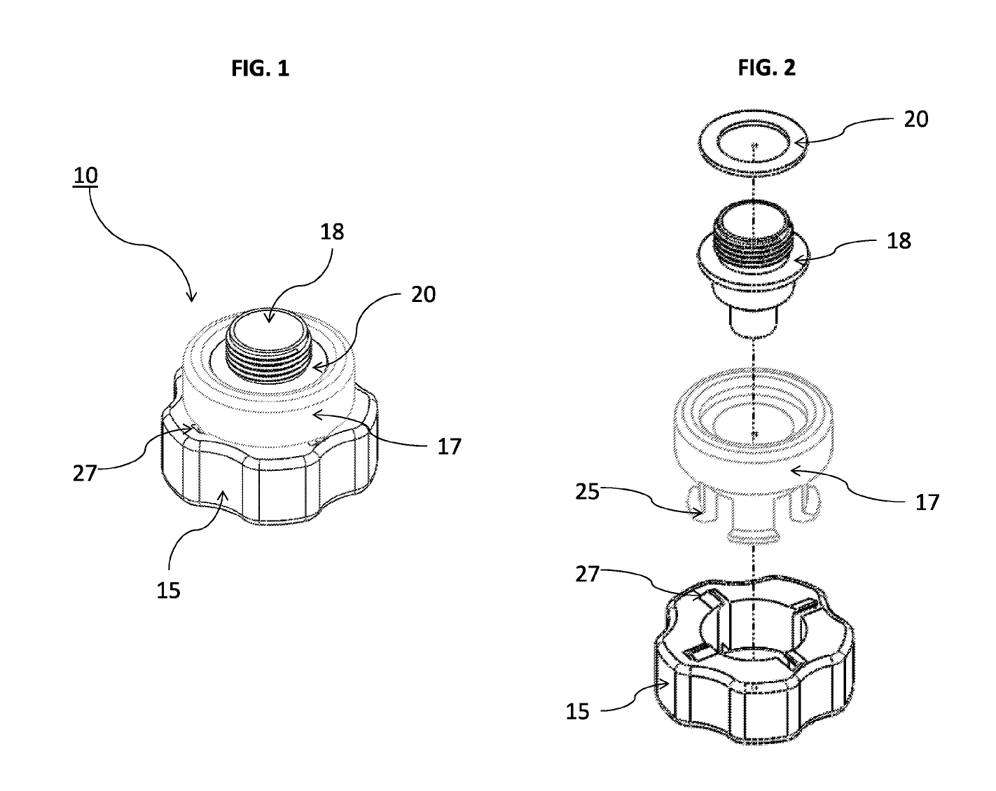

The fluid connector assembly and methods described herein are relatively easy to tighten by hand, can be fastened to one or more conventional fluid supply lines, and comprise features that prevent a respective assembly from being overtightened when being assembled and fastened to another. FIGS. 1 and 2 depicts a fluid connector assembly 10 comprising an outer fastener 15 such as a nut, a fastener insert 17 such as an inner ring, an externally threaded connector 18, and a seal 20. FIG. 2 depicts an exploded view of the embodiment of FIG. 1, wherein connector assembly 10 may be assembled by operatively connecting seal 20, connector 18, fastener insert 17, and outer fastener 15 to each other. Threads of connector 18 are positioned on an external surface of connector 18. Radial members 27 may be positioned on the upper surface of outer fastener 15.

Radial members 27 may comprise one or more slots and/or projections that protrude from the upper mounting surface of outer fastener 15. In the preferred embodiment, connector assembly 10 comprises a plurality of four members 27 arranged on the upper surface of outer fastener 15. However, in other embodiments, outer fastener 15 may comprise only one radial member 27 or may comprise two or more radial members 27.

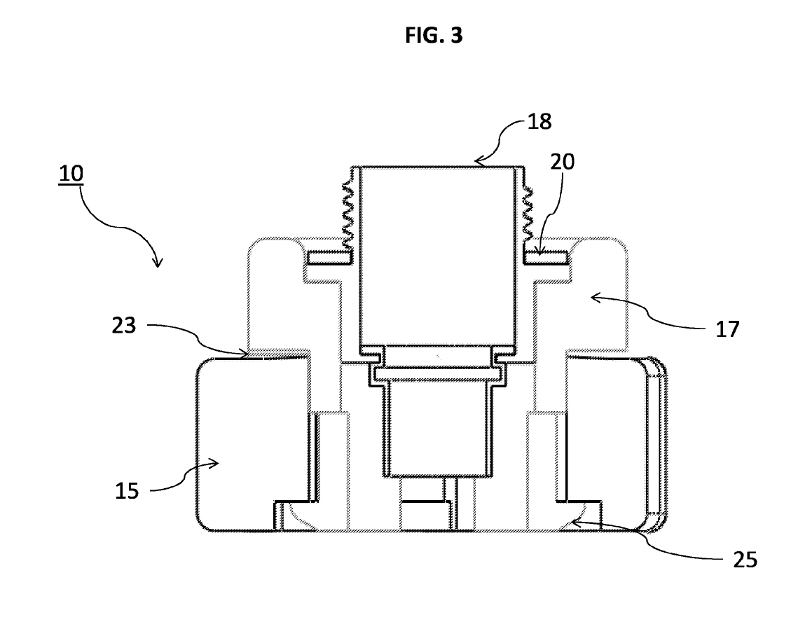

FIG. 3 depicts one embodiment of a cross section of externally threaded connector assembly 10 showing how components of the assembly interconnect. Seal 20 may be disposed on the upper surface of a flange or shoulder of connector 18 so as to hermitically seal against a fluid supply line that is introduced to connector 18. In some embodiments, seal 20 may not be provided since annular shoulder or flange of connector 18 may provide sufficient sealing to the supply line to which connector assembly 10 is connected. In a preferred embodiment, seal 20 is be ultrasonically welded to connector assembly 10 at a predetermined location. However, seal 20 may also be welded, bonded, adhered to, or otherwise assembled in connector assembly 10 as desired. In practice, the flange or shoulder operatively connects to annular recess of fastener insert 17 so that an upper portion of connector 18 is arranged above annular recess of fastener insert 17 when assembled and a lower portion of connector 18 is arranged below. In turn, the lower mounting surface of fastener insert 17 may be configured to communicate with upper surface of outer fastener 15.

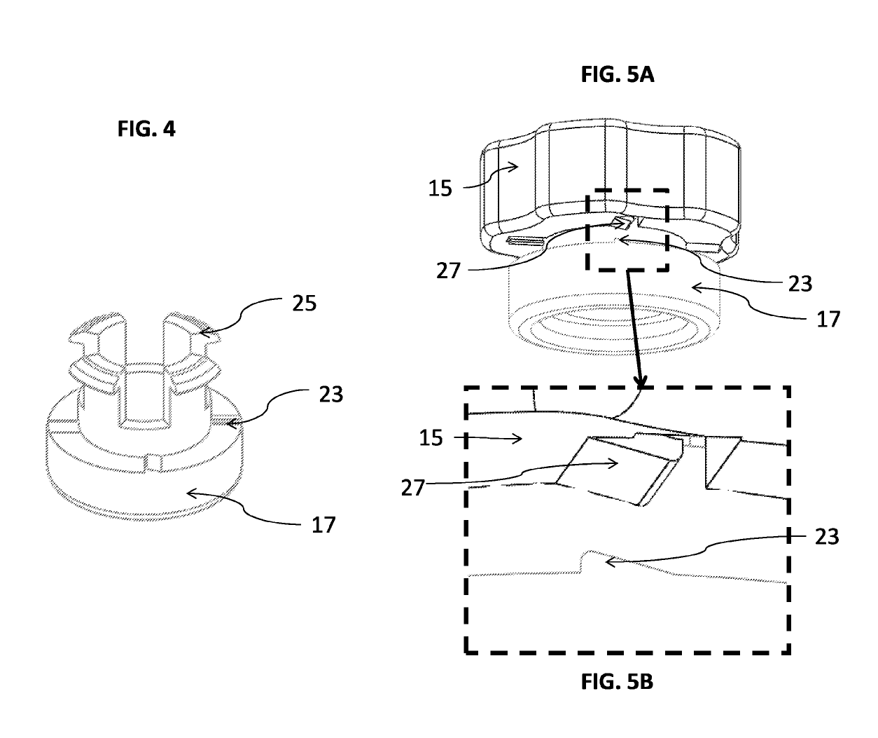

FIG. 4 depicts fastener insert 17 oriented so that the lower mounting surface of fastener insert 17 is pointed upwards. It can be seen that radially extending projections 23 of fastener insert 17 protrude from the lower mounting surface of the fastener insert 17 that mounts to the upper surface of outer fastener 15 so that projections 23 correspond to radial members 27 when connector assembly 10 is assembled. Fastener insert 17 may further comprise one or more axially extending, flexible projections 25 that protrude from the lower mounting surface of the fastener insert 17 to secure fastener insert 17 to the lower surface of outer fastener 15. In this embodiment, outer fastener 15 snaps onto fastener insert 17 when axial projections 25 telescopically slide through outer fastener 15 and mate to a lower surface of outer fastener 15 which in some embodiments is annular recess corresponding to outwardly extending shoulders of projections 25.

In practice, when connector assembly 10 is assembled, connector assembly 10 is capable of being fastened to multiple types of fluid supply lines such as a fluid hose arranged to operatively connect to externally threaded connector 18. Connector assembly 10 tightens to the source of fluids by rotating externally threaded connector 18 to the supply line in a predetermined direction (e.g. clockwise or counter-clockwise depending design or preference). When a predetermined torque is reached, radial members 27 of outer fastener 15 are configured to slip or pass over projections 23 of fastener insert 17. Moreover, rotating connector assembly 10 the opposite direction can maintain the predetermined torque but can also cause connector assembly 10 to be loosened if desired. Therefore, a user or the like is unable to overttighten connector assembly 10 to the supply line which is particularly advantageous since the user does not have to use a specific tool such as a torque wrench or the like, be concerned with destroying connector assembly 10 or the corresponding supply line due to overtightening which conserves resources. This is because many connectors and components to which they connect are thereby conserved from incurring future physical harm. In some embodiments, radial members 27 passing over radial projections 23 causes a sound to be emitted indicating to the user that the predetermined torque of connector assembly 10 has been achieved.

FIG. 5A depicts fastener insert 17 oriented similarly to FIG. 4, wherein annular recess of fastener insert 17 is pointed downwards so that the interconnection and the interference fit between members 27 and projections 23 can be observed. FIG. 5B depicts a close up view of one member 27 arranged so that when outer fastener 15 assembles with fastener insert 17, the one member 27 will pass over projection 23 when the predetermined torque of connector assembly 10 has been achieved. In some embodiments, members 27 of fastener 15 may be flexible. Members 27 preferably comprise a modulus of elasticity so that members 27 can bend and pass over projection 23. It is understood that projections 23 may alternatively be configured to be flexible such that when connector assembly 10 is tightened to a predetermined torque, projections 23 flex and pass over members 27.

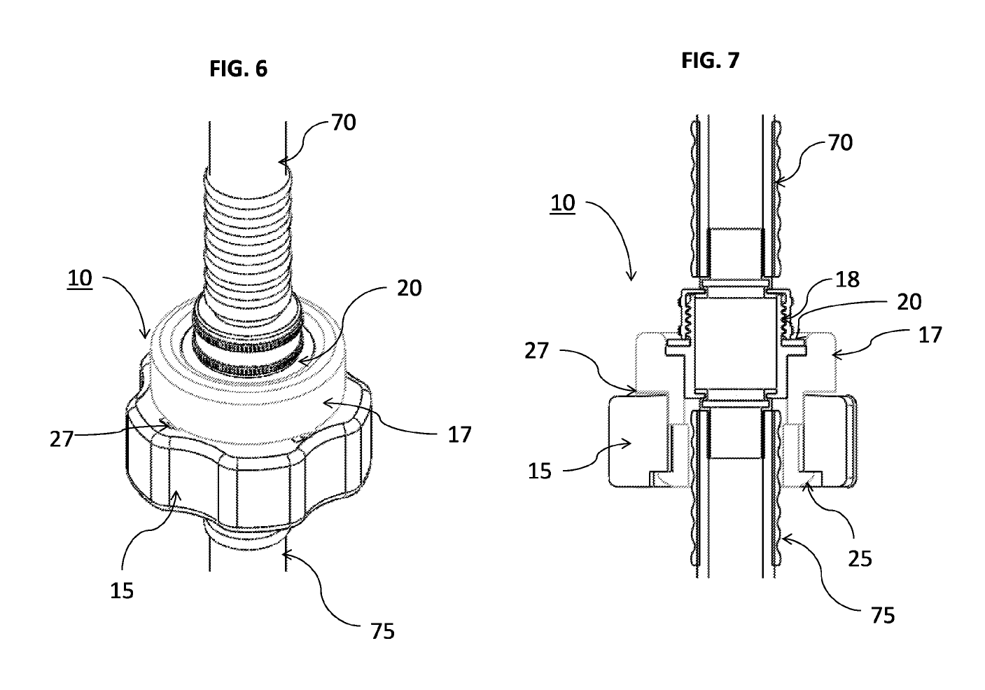

FIGS. 6-7 depict connector assembly 10 in use with a source of fluids such as a conventional garden hose 70 fastened to connector assembly 10 at seal 20 and connector 18 (i.e. the male end of connector assembly 10 into female threaded fastener of hose 70). Therebelow, it can be seen that outer fastener 15 operatively connects to a second source of fluids 75. In some embodiments, source 75 fastens to outer fastener 15 by being crimped, welded, bonded, sealed, or the like to the lower portion of outer fastener 15 so that sources 75 and 70 are in fluid communication with each other. To ensure that connector assembly 10 and hose 70 do not overttighten when being assembled, one or more of members 27 and corresponding projections 23 are provided as described previously so that the predetermined torque is not exceeded.

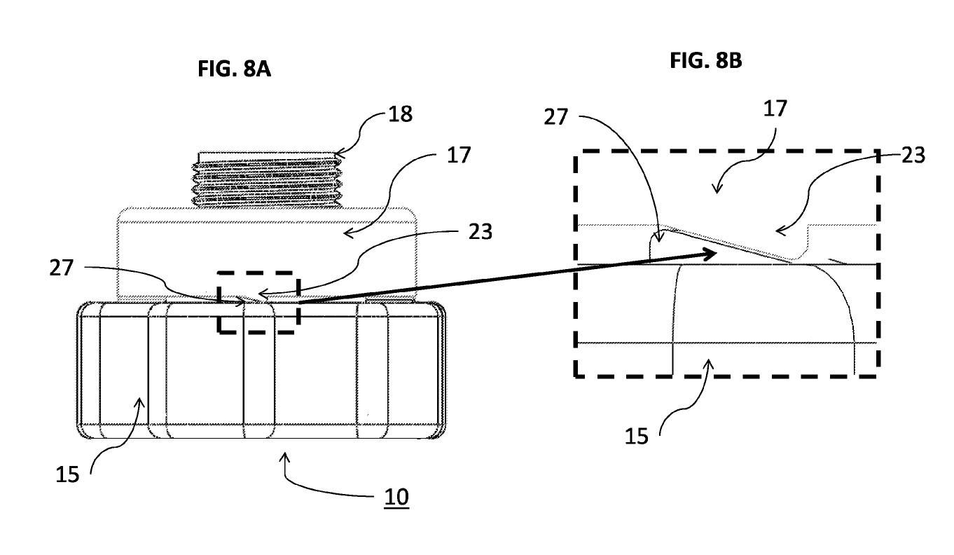

FIG. 8A depicts a side plan view of connector assembly 10 according to one embodiment, wherein the upper surface of connector 18 is facing upward and is ready to be introduced into a fluid supply line, hose, or the like. FIG. 8B depicts a close up view of radial members 27 when assembled with projections 23. It can be seen that members 27 and projections 23 comprise corresponding shapes which may be angled protrusions with one or more lips so that rotation of outer fastener 15 or fastener insert 17 with respect to each other naturally causes members 27 and projections 23 to contact each other until reaching the predetermined torque. As can be seen, when the predetermined torque of connector assembly 10 is reached, the leading edge of each projection 23 rotates until it is received by member 27. As previously described, interconnection of members 27 of outer fastener 15 with projections 23 of fastener insert 17 may produce a click sound or the like when the predetermine torque of connector assembly 10 is reached caused by members 27 or projection 23 passing over the other (i.e. when fastener insert 17 and outer fastener 15 are overtightened to each other).

Outer fastener 15 and/or fastener insert 17 may be customized according to required torque and specific design needs such as hose or pipe diameter, fluid pressure, or specific predetermined torque value, etc. Further, in embodiments such as those described in FIGS. 6-7, once hose 75 is crimped or otherwise connected to connector assembly 10, hose 70 is incapable of connecting to connector 18 in excess of the predetermined torque thus ensuring structural integrity of all components of connector assembly 10 and components operatively connected thereto. To that end, when a loosening torque (i.e. a torque applied in the opposite direction of tightening) is applied to connector assembly 10 or any component operatively connected thereto, interconnection of members 27 and projections 23 do not slip over each other. Further, a torque load greater than the predetermined torque can be applied to loosen connector assembly 10.

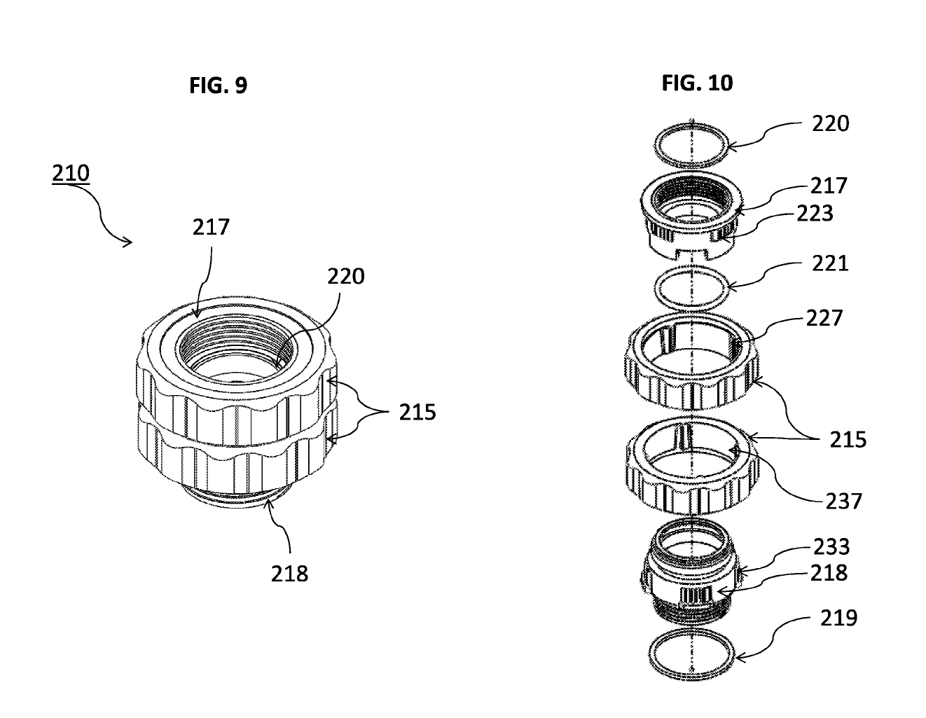

FIG. 9 depicts a perspective view of another embodiment of a fluid connector assembly 210 with external threads that may comprise a dual end click seal. Connector assembly 210 may comprise a first seal 220, an upper fastener insert 217, an outer fastener 215, and a lower fastener insert 218. Fastener insert 217 is configured as a female fluid connector with internal threading configured to receive a fluid supply line with external threading. Outer fastener 215 is shown comprising an upper portion and a lower portion, wherein upper and lower portion are two distinct components. Fastener 215 in some embodiments may be an internally threaded nut.

Connector assembly 210 can be seen comprising an upper portion and a lower portion. To more clearly view components of connector assembly 210, FIG. 10 depicts an exploded view of connector assembly 210. The upper portion of connector assembly 210 may comprise first seal 220, upper fastener insert 217, O-ring 221, and upper portion of fastener 215, wherein the upper portion of connector assembly 210 comprises internal threading. Upper portion of outer fastener 215 may be a nut and upper fastener insert 217 may be an inner ring. The lower portion of connector assembly 210 may comprise the lower portion of fastener 215, lower fastener insert 218, and a second seal 219, wherein the lower portion of connector assembly 210 comprises external threading. The lower portion of outer fastener 215 may be a nut and lower fastener insert 218 may be an inner ring.

In some embodiments, fastener inserts 218 and 217 are configured to snap onto each other when connector assembly 210 is assembled. Similar to connector assembly 10, connector assembly 210 provides an interference fit between fastener insert 217 and fastener 215. The interference fit may be provided by a first interference fit between outwardly extending axial projections 223 comprised by fastener insert 217 and corresponding inwardly extending axial members 227 disposed on the inner surface of the upper portion of fastener 215. Members 227 may comprise projections and slots that correspond to projections 223 of fastener insert 217.

A second interference fit may also be provided between outwardly extending axial projections 233 of fastener insert 218 and corresponding inwardly extending axial members 237 disposed on the inner surface of the lower portion of fastener 215. Members 237 may likewise comprise projections and slots that correspond to projections 233 of fastener insert 218. Connector assembly 210 may therefore comprise interference fits on both the upper and lower portions of connector assembly 210.

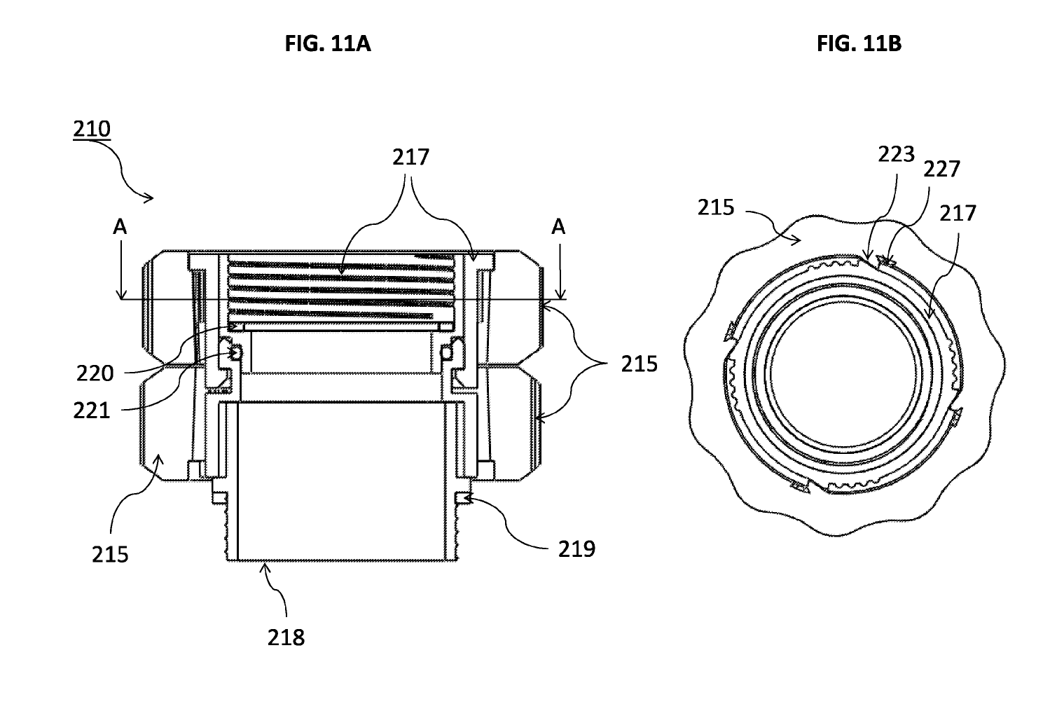

FIG. 11A depicts a side plan view of a cross section defined by the center line of embodiments of FIGS. 9-10 illustrating the various features of connector assembly 210, wherein fastener insert 217 comprises internal threading and fastener insert 218 comprises external threading. It can be seen that inserts 217 and 218 provide fluid communication between fluid sources through upper and lower portions of connector assembly 210, wherein optional seals 220, 221, and 219 may be included to form hermetic seals between fluid sources such as conventional fluid hoses or the like and corresponding annular shoulders or flanges of associated inserts 217 and 218. It can be seen that seal 219 may provide adequate sealing between annular shoulder of fastener insert 218 and a fluid source introduced through threading of fastener insert 218. Similarly, seal 220 may provide adequate sealing between the annular shoulder of fastener insert 217 and a fluid source introduced through threading of fastener insert 217. Seal 221 which may be an O-ring may provide adequate sealing between rings 217 and 218. Seals and O-rings may be provided in any of the connector assemblies described herein to provide proper sealing and avoid fluid leakage as needed.

FIG. 11B depicts a top plan view of connector assembly 210 of FIG. 11A taken along section A-A depicting one embodiment of the first interference fit between fastener insert 217 and upper portion of fastener 215. The interference fit between outwardly extending axial projections 223 of fastener insert 217 corresponds to and contacts inwardly extending axial members 227 disposed on the inner surface of the upper portion of fastener 215 so that during tightening, once the predetermined torque is achieved, members 227 pass over corresponding projection 223 and emit the predetermined sound (e.g. a click). This sound which can be a click or a ratchet indicates that the connector assembly 210 is assembled properly and ready for use. The second interference fit between fastener insert 218 and the lower portion of fastener 215 may comprise similarly shaped members 237 and projections 233 so that overtightening during assembly with a fluid supply line is avoided.

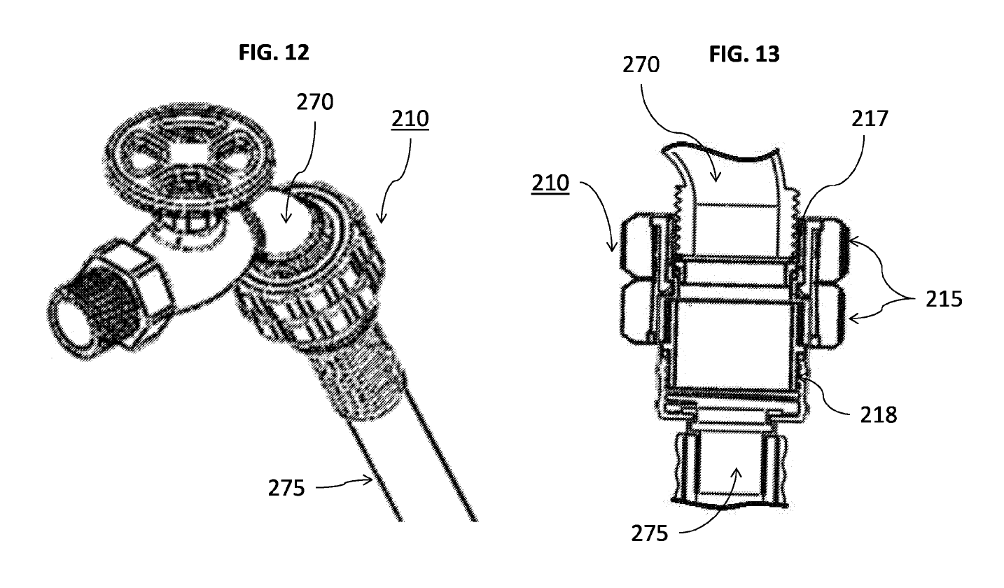

FIGS. 12-13 depict connector assembly 210 while in use with fluid sources such as a conventional fluid hose 275 and a hose in communication with fluid valve 270 such as a residential water spigot. It can be seen that spigot 270 is inserted into and fastened with internal threads of fastener insert 217. Hose 275 is inserted onto and fastened with external threads of fastener insert 218 thereby providing fluid communication between each of sources 270 and 275 and connector assembly 210. The above-described interference fits provided between inserts 217 and 218 when assembled with fastener 215 ensure that sources 270 and 275 do not exceed the predetermined torque when tightened to associated inserts 217 and 218 of connector assembly 210 thereby protecting structural integrity of sources 270 and 275, all components comprised by connector assembly 210, and most importantly, ensuring that desired flow characteristics of fluids flowing between 270, 210, and 275 are achieved. Further, a user is not required to use a special tool to assemble or tighten connector assembly 210 to sources 270 and 275.

FIGS. 14-17 depict alternative embodiments of the connector assembly described herein, wherein the fastener inserts inserted into outer fasteners of the connector assembly each comprise alternative approaches to positioning of respective fastener insert threading.

FIG. 14 illustrates a side plan view of connector assembly 310 along center line of connector 310 similarly comprising outer fastener 315 with an upper and a lower portion. Upper and lower portions of fastener 315 may each be fasteners such as a nut configured to receive a fastener insert. Upper portion of fastener 315 may be configured to receive upper fastener insert 317 with internal threading. Lower portion of fastener 315 may be configured to receive lower fastener insert 318 similarly with internal threading such that both inserts 317 and 318 comprise internal threading.

This is particularly advantageous for fluid connectors where it is desired to provide fluid communication between two fluid hoses arranged on opposite mating ends of connector assembly 310. Connector assembly 310 in turn may comprise certain features such as seals 321 and 319 as desired for improved sealing between adjoining features and surfaces. Similar to connector assemblies 10 and 210, connector assembly 310 comprises an interference fit between insert 317, fasteners 315, and insert 318. The interference fit in this embodiment may be provided between outwardly extending axial projections 323 of insert 317 and corresponding inwardly extending axial members 327 positioned on the inner surface of the upper portion of fastener 315. Members 327 may comprise projections and slots that correspond to projections 323 of insert 317.

A second interference fit may also be provided between outwardly extending axial projections 333 of insert 318 and corresponding inwardly extending axial members 337 disposed on the inner surface of the lower portion of fastener 315. Members 337 may likewise comprise projections and slots that correspond to projections 333 of insert 318. Connector 310 may therefore comprise interference fits on both the upper and lower portions of connector 310.

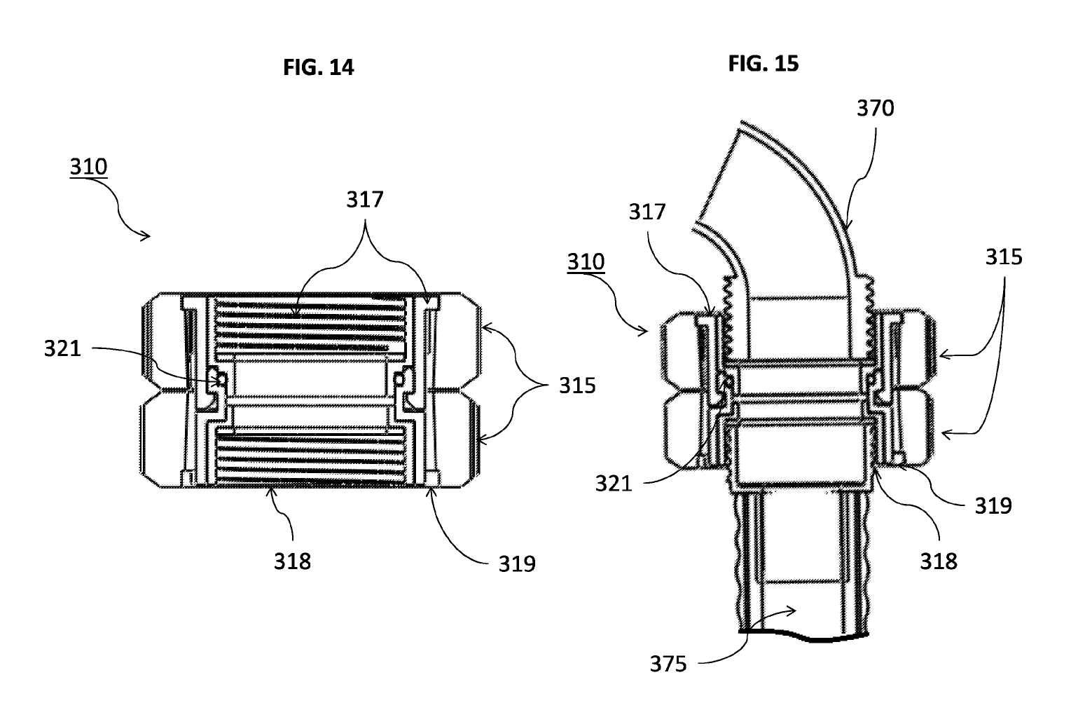

FIG. 15 depicts connector assembly 310 of FIG. 14 in use with fluid sources such as a conventional fluid hose and a supply line extending from a valve. Connector assembly 310 is therefore in fluid communication and fastened with a source of fluids such as a conventional fluid hose 375 and a residential water spigot 370. Spigot 370 is inserted into and fastened wiht internal threads of insert 317. Hose 375 is inserted into and fastened with internal threads of insert 318 thereby providing fluid communication between each of sources 370 and 375 with the above-described interference fits provided between inserts 317 and 318 when assembled with fastener 315.

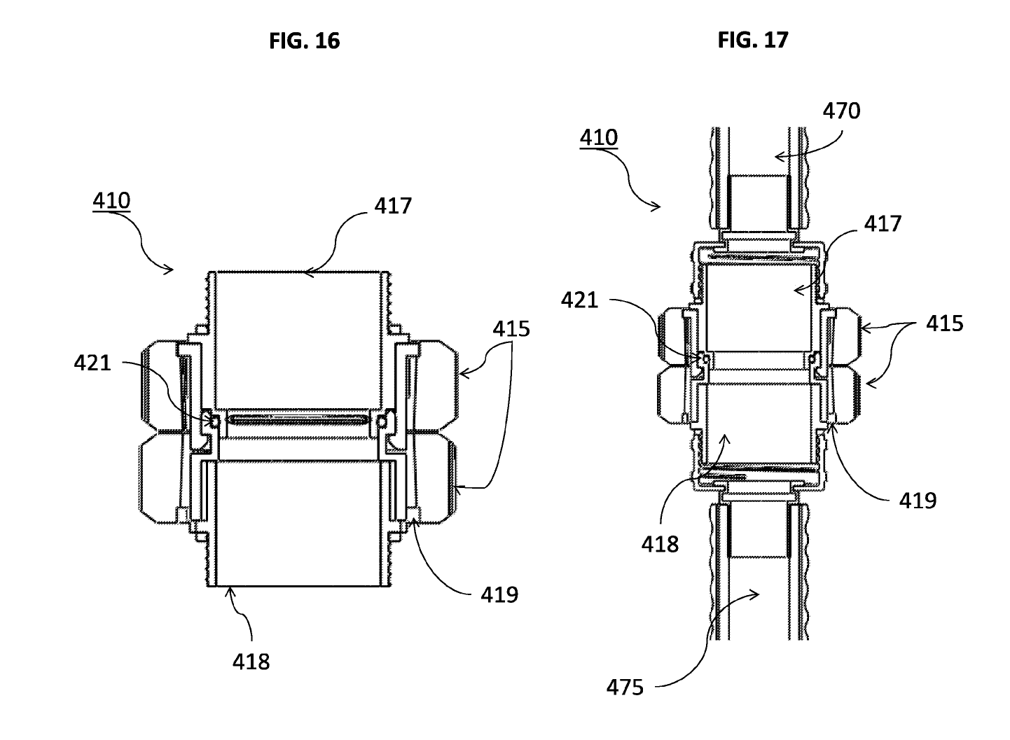

The embodiment of connector assembly 410 depicted in FIG. 16 is similar to connector assemblies 10, 210, and 310, wherein threading of inserts 417 and 418 are each positioned externally so that fluid supply lines connected thereto may comprise internal threading sized to correspond and connect to external threading of inserts 417 or 418.

FIG. 17 depicts connector assembly 410 of FIG. 16 in use with fluid sources such as two conventional fluid hoses 475 and 470 with female fluid connectors comprising internal threading. Connector 410 therefore provides fluid communication between the two fluid hoses 475 and 470 by being inserted onto and fastened with respective external threading of inserts 417 and 418, wherein the above-described interference fits provided between rings 417 and 418 when assembled with fasteners 415 ensures that overtightening is avoided and proper sealing and tightening between sources 470 and 475 and connector assembly 410 is achieved.

It is understood that any of the fasteners, inserts, seals or other features of connectors 10, 210, 310, and 410 may be sonic welded to each other, bonded, adhered using an adhesive, or the like.

What has been described above includes examples of one or more embodiments. It is, of course, not possible to describe every conceivable combination of components or methodologies for purposes of describing the aforementioned embodiments, but one of ordinary skill in the art may recognize that many further combinations and permutations of various embodiments are possible. Accordingly, the described embodiments are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1. A fluid connector assembly, comprising:
an outer fastener comprising a top surface, a bottom surface, and a plurality of radially extending members on the top surface;
an inner fastener comprising a top surface, a bottom surface, and a plurality of radially extending projections dimensioned to be received by the radially extending members when the inner fastener is assembled with the outer fastener; and
a connector disposed in the inner fastener.

2. The assembly of claim 1, wherein the connector is externally threaded.

3. The assembly of claim 2, further comprising a seal in communication with the connector.

4. The assembly of claim 3, wherein the connector further comprises a shoulder in communication with the seal.

5. The assembly of claim 1, wherein the radially extending projections of the inner fastener are received by the radially extending members of the outer fastener, wherein when a predetermined torque is reached, the radially extending projections slip out of the radially extending members passing over the top surface of the outer fastener and preventing the predetermined torque from being exceeded.

6. The assembly of claim 5, wherein the radially extending projections of the inner fastener do not slip out of the radially extending members when a loosening torque is applied.

7. The assembly of claim 6, wherein the loosening torque is greater than the predetermined torque.

8. The assembly of claim 1, wherein the connector operatively connects to a first fluid supply line and the outer fastener operatively connects to a second fluid supply line.

9. (canceled)

10. The assembly of claim 8, wherein the second supply line is crimped to the outer fastener.

11. (canceled)

12. (canceled)

13. A method of connecting fluid supply lines to a fluid connector assembly, comprising:
(a) providing a first fluid supply line with internal threads;
(b) fastening an externally threaded connector assembly to the internal threads of the first supply line, wherein the externally threaded connector assembly comprises:
(i) an outer fastener comprising a top surface, a bottom surface, and a plurality of radially extending members on the top surface;
(ii) a fastener insert comprising a top surface, a bottom surface, external threads, and a plurality of radially extending projections dimensioned to be received by the radially extending members when the fastener insert is assembled with the outer fastener;
(c) rotating the outer fastener to rotably tighten the externally threads of the fastener insert to the internal threads of the first fluid supply line until a predetermined torque is reached;
wherein if the outer fastener continues to be rotated after the predetermined torque is reached, the radially extending projections of the fastener insert slip over the radially extending projections of the outer fastener.

14. The method of claim 13, wherein the first fluid source is a pipe, a toilet tank, a spigot, or a fluid hose.

15. A fluid connector assembly, comprising:
a first and a second outer fastener, each outer fastener comprising a front surface, a back surface, and a plurality of inwardly extending axial portions separated by axially extending slots; and
a first and a second fastener insert, each fastener insert comprising a front surface, a back surface, threading, and a plurality of outwardly extending axial projections configured to be received by the axially extending slots when an associated fastener insert is assembled with an associated outer fastener;
wherein the first fastener insert is received by the first outer fastener and the second fastener insert is received by the second outer fastener; and
wherein the first and second fastener inserts interlock after being received by an associated outer fastener.

16. The assembly of claim 15, wherein a first fluid supply line with threading is fastened to the assembly through the threading of the first fastener insert.

17. The assembly of claim 15, wherein a second fluid source with threading is fastened to the assembly through the threading of the second fastener insert.

18. The assembly of claim 15, wherein a second fluid source with threading is fastened to the assembly through the threading of the second fastener insert.

19. The assembly of claim 15, wherein the threading of each of the first and second fastener inserts is internal threading.

20. The assembly of claim 15, wherein the threading of each of the first and second fastener inserts is external threading.

21. (canceled)

22. (canceled)

23. The assembly of claim 15, wherein the first and second fastener inserts are configured to snap onto each other after being received by an associated outer fastener.

24. (canceled)

25. (canceled)

26. The system of claim 15, wherein the axially extending projections of the second fastener insert are received by the axially extending slots of the second outer fastener, wherein when a predetermined torque is reached, the outwardly extending projections of the second fastener insert slip over the inwardly extending axial portions of the second outer fastener to prevent the predetermined torque from being exceeded.

27. The assembly of claim 26, wherein the outwardly extending projections of the first and second fastener inserts are flexible.

28. The assembly of claim 27, wherein the outwardly extending projections of the first and second fastener inserts do not slip over the inwardly extending axial portions of the first and second outer fastener when a loosening torque is applied.

29. The assembly of claim 28, wherein the loosening torque is greater than the predetermined torque.

30. The assembly of claim 26, wherein the predetermined torque is adjustable.

31. A method of connecting fluid supply lines to a fluid connector assembly, comprising:
(a) providing a first fluid supply line with threading;
(b) fastening the threading of the first fluid supply line to a threaded connector assembly, wherein the threaded connector assembly comprises:
(i) a first and a second outer fastener, each outer fastener comprising a front opening, a back opening, and a plurality of inwardly extending axial portions separated by axially extending slots; and
(ii) a first and a second fastener insert, each fastener insert comprising threading, a front opening, a back opening, and a plurality of outwardly extending axial portions configured to be received by the axially extending slots when an associated fastener insert is assembled with an associated outer fastener; wherein the first outer fastener is assembled with the first fastener insert and the second outer fastener is assembled with the second fastener insert; and
wherein the first and second fastener inserts interlock with each other at a corresponding back opening;
(c) rotating the first outer fastener to rotably tighten the threading of the first fastener insert to the threading of the first fluid supply line until a predetermined torque is reached; and
wherein if the first outer fastener continues to be rotated after the predetermined torque is reached, the outwardly extending projections of the first fastener insert slip over the inwardly extending axial portions of the first outer fastener to prevent the predetermined torque from being exceeded.

32. The method of claim 31, further comprising:
(d) providing a second fluid supply line with threading; and
(f) rotating the second outer fastener to rotably tighten the threading of the second fastener insert to the threading of the second fluid supply line until the predetermined torque is reached; and
wherein if the second outer fastener continues to be rotated after the predetermined torque is reached, the outwardly extending projections of the second fastener insert slip over the inwardly extending axial portions of the second outer fastener to prevent the predetermined torque from being exceeded.

33. The method of claim 32, wherein the first or second fluid supply line is a pipe, a toilet tank, a fluid spigot, or a fluid hose with internal threading.

34. (canceled)
